(19) United States
(12) Patent Application Publication
(10) Pub. No.: US 2026/0004426 A1
(43) Pub. Date: Jan. 1, 2026

(54) GENERATING AN INTERMEDIATE IMAGE IN MEDICAL IMAGING

(71) Applicant: Siemens Healthineers AG, Forchheim (DE)

(72) Inventor: Alois Regensburger, Poxdorf (DE)

(21) Appl. No.: 19/256,505

(22) Filed: Jul. 1, 2025

(30) Foreign Application Priority Data
Jul. 1, 2024 (DE) 10 2024 206 137.9

(51) Int. Cl. G06T 7/00; G06T 7/215; G06T 7/246; G06T 7/73; G06T 11/00

(52) U.S. Cl. CPC G06T 7/0016; G06T 7/215; G06T 7/251; G06T 7/73; G06T 11/005; G06T 11/008; G06T 2207/10088; G06T 2207/10116; G06T 2207/10132; G06T 2207/20016; G06T 2207/20081; G06T 2207/30021; G06T 2207/30101; G06T 2211/416

(57) ABSTRACT

In medical imaging, image sequences may be perceived more smoothly. Therefore, a method for generating an intermediate image in medical imaging is provided. A first image and a second image of an object are obtained with an imaging sensor. In the first image, an image section of the object and a further image section are represented in a relative position to one another. Further, motion information relating to the object is obtained independently of the first image and the second image of the imaging sensor. An intermediate image is generated for presentation between the first image and the second image. In the intermediate image, a relative position between the image section of the object and the further image section is changed in dependence on the motion information compared to the first image. The intermediate image is generated before the second image is available for presentation.

This application claims the benefit of German Patent Application No. DE 10 2024 206 137.9, filed on Jul. 1, 2024, which is hereby incorporated by reference in its entirety.

### BACKGROUND

The present embodiments relate to a method for generating an intermediate image in medical imaging, a method for controlling medical imaging, a medical imaging apparatus, and a computer program.

During imaging of an examination object (e.g., intraoperative and/or interventional imaging), a plurality of images (e.g., a video sequence) of the examination object is recorded by a medical imaging device in a temporal sequence. Herein, a change (e.g., a temporal and/or spatial change) in an examination area of the examination object may be observed in real time by a medical operator (e.g., a physician) by displaying a graphical representation of the plurality of images (e.g., the video sequence). An example of such real-time imaging is X-ray fluoroscopy. Herein, the examination area may be imaged on a detector under repeated X-ray fluoroscopy. During X-ray fluoroscopy, a low frame rate is often selected in order to reduce the X-ray dose. The low frame rate may have the disadvantage that the graphical representation of the images of the examination area displayed in real time is subject to jerking. As a result, the visual impression of the video sequence is often not smooth.

In addition, a low-latency display of the graphical representation of the images of the examination area may be advantageous for reliable monitoring of the change in the examination area (e.g., a motion).

For a smoother visual impression, there are, for example, methods in television technology for calculating intermediate images between two consecutive images in a video sequence. However, since this calculation of the intermediate images requires knowledge of the next image in the video sequence in each case, this would delay the display of the graphical representation of the current image of the examination area in each case by half an image recording period, and this may adversely affect the observation of the change in the examination area in real time.

Computer games (e.g., action games) may require a sequence of images to be represented with a high frame rate, where the latency (e.g., delay) of the image display should be as low as possible. A user should be able to respond as quickly as possible to the current game situation via the perceived image content.

However, if no additional display latency is allowed, as in certain computer games in which the user is required to respond as quickly as possible to the game situation, the intermediate image is to be calculated in advance from the old image or the old rendered frame without a new image or a new rendered frame already being available. Therefore, this involves a temporal extrapolation of the previously displayed image sequence, which should be as consistent as possible with the future new image, but this is as yet unknown. In other words, the temporally extrapolated intermediate image should deviate as little as possible from a retrospective interpolation.

For computer games, there is an algorithm that makes this possible. See, for example, https://gpuopen.com/gdc-presentations/2023/GDC-2023-Temporal-Upscaling.pdf

Document DE 10 2021 210 283 A1 discloses a method for generating an intermediate image, where different processing functions are applied to an initialization image.

In addition, document DE 10 2021 214 741 B3 discloses a method for generating synthetic X-ray images using a neural network.

Independent of the grammatical term usage, individuals with male, female, or other gender identities are included within the term.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, low-latency processing and smooth graphical representation of image data of a medical examination object are enabled.

Accordingly, according to the present embodiments, a method is provided for generating an intermediate image in medical imaging. The intermediate image is an image to be presented between a first image and a second image. The intermediate image may be a synthetic image that is generated differently than the first image and the second image. The method relates to the field of medical imaging, such as, for example, computed tomography, fluoroscopy, magnetic resonance imaging, angiography, ultrasound imaging, and the like.

In a first act of the method according to the present embodiments, a first image and a second image of an object are obtained using an imaging sensor, where, in the first image, an image section of the object and a further image section are represented in a relative position to one another. Therefore, the imaging sensor records two images each representing the object to be examined. The first image represents two different image sections in which, for example, a first image section represents a vascular branch, and the second section represents a catheter.

The two image sections (e.g., the vascular branch and the catheter) have a relative position to one another. This relative position may, for example, be expressed by a vector with a length and an angle in a predefined coordinate system.

In a further act of the method according to the present embodiments, one or more items of motion information relating to the object are obtained independently of the first image and the second image of the imaging sensor. In other words, one or more items of motion information relating to the object represented in the first image section is obtained. However, this motion information is not obtained from the first image and the second image, but is independent of both images. For example, the motion information may also be independent of all images from the imaging sensor. This provides that the motion information is captured or obtained with one or more capturing facilities other than the imaging sensor. For example, the respective imaging information is obtained with an additional device, such as a camera or an EEG device.

In a further act, an intermediate image is generated for presentation between the first image and the second image, where, in the intermediate image, the relative position between the image section of the object and the further image section is changed in dependence on the motion information compared to the first image. The intermediate image is not generated directly by the imaging sensor. Rather, the intermediate image is, for example, calculated artificially from other items of image information or motion information. The intermediate image is presented between the first image and the second image so that a smooth video impression is created despite a lower frame rate of, for example, 30 to 60 fps. In this example, the frame rate may thus be doubled to 60 to 120 fps with the intermediate image presentation. If necessary, further intermediate images may also be inserted between two “real” images in order to further increase the frame rate.

The relative position between the image section of the object and the further image section is changed according to the motion information in the intermediate image. For example, the catheter is closer to the vascular junction in the intermediate image. Therefore, the catheter (e.g., the image section of the object) is represented in the intermediate image closer to the further image section reflecting the vascular junction. In one embodiment, it is provided that the intermediate image is only generated in dependence on the first image and the motion information. Therefore, no further information is required to generate the intermediate image, which allows for rapid generation of the intermediate image.

The intermediate image is generated (e.g., completely, if necessary) before the second image is available for presentation. This provides that the intermediate image is generated without the information from the second image (e.g., also independently thereof). For example, the intermediate image is presented before the processing of recording data for the second image has begun or is fully completed. Hence, the intermediate image is presented before the presentation of the second image may even begin.

Hence, a smoother image perception may be achieved (e.g., for X-ray procedures with high frame rates). Psychologically, the perception of the image sequence is much smoother, thus facilitating a rapid response to the image content represented. This may be advantageous during cardiac catheterization interventions, for example.

At high X-ray frame rates of, for example, 60 fps, there will be only a very slight deviation from the “real” X-ray images in the intermediate images. Hence, the technique allows a smoother image perception without the risk of X-ray images being distorted by algorithms. The method may therefore be used particularly advantageously for interventions requiring rapid responses.

In one example embodiment, medical imaging is based on X-rays, magnetic resonance, or ultrasound. The imaging may also be based on different physical principles, but also benefits from the aforementioned advantages.

According to a further example embodiment, it is provided that the intermediate image is calculated by a computing facility solely based on the first image and the motion information. Therefore, as already indicated above, a separate image is not taken by the imaging sensor for the intermediate image. Rather, the intermediate image is generated based on an image that precedes the intermediate image.

In another example embodiment, the motion information is obtained independently of all images from the imaging sensor. Therefore, a different source of information than the imaging sensor is used for the imaging information. Such an information source may be a further sensor on or in the corresponding imaging apparatus. Alternatively, the information source may also, for example, be a control unit with which the corresponding imaging apparatus is controlled.

According to a further example embodiment, it is provided that the motion information is obtained by a camera with which the object is recorded independently of the imaging sensor. This provides that the motion information relating to the object is obtained with the aid of a camera that provides optical image data of the object. A specific example is a C-arm device that has an X-ray detector as an imaging sensor. The camera for recording the optical image data of the object may, for example, be attached to the C-arm. Hence, the camera has a fixed relative position to the C-arm, so that motion information obtained by the camera or subsequent data processing is also useful for the X-ray image, since the object moves relative to the camera in the same way as the object moves relative to the C-arm. The camera may also be attached at other locations, such as at a specific position in the respective room, on a housing of the imaging system of the imaging sensor, on a patient table, and the like.

According to a further example embodiment, the motion information is obtained with the aid of a tracking system or a motion model. Herein, the motion information may be ascertained solely or additionally with the tracking system or the motion model. The tracking system may, for example, be used to track needles, catheters, and the like. Depending on the embodiment, the tracking system provides ultrasound images, optical images, X-ray images, and the like, and a corresponding evaluation based on the images obtained. The motion model may, for example, be used to predict cyclic motions resulting, for example, from the heartbeat or respiration. The motion information obtained thereby may be used for temporal extrapolations to generate the intermediate image.

Alternatively or additionally, in one example embodiment, the motion information is obtained from control data for the motion and/or from motion data from the imaging sensor. For example, a C-arm device is used as the imaging system. The control data for controlling the C-arm is present in the imaging system. This control data may be used to ascertain the motion information for the intermediate image. Alternatively or additionally, motion data from the imaging sensor may also be used to ascertain the motion information. This motion data may be obtained from an additional sensor that records or captures the motions of the imaging sensor. The motion data captured in this way reflects the actual motion of the imaging sensor.

In a further example embodiment, the motion information is obtained with the aid of a non-imaging medical examination device. For example, cardiac phase detection is performed on a patient. The corresponding motion information may be ascertained from the phases obtained thereby. The same applies to other non-imaging examination devices that, for example, capture EEG signals, respiratory motion cycles, and the like. It is also possible, for example, to use the signal from a ventilator to estimate the motion information.

According to one example embodiment, the object is a medical instrument. For example, the medical instrument is a catheter, a needle, a cannula, or the like. For example, when inserting such instruments into vessels, it is desirable that a smooth image sequence is available. Therefore, it is important to obtain the corresponding motion information from these instruments and use the motion information for the intermediate images.

In a further example embodiment, it is provided that, in addition to the motion information, segmentation information is obtained from images from the imaging sensor, and from this, further motion data is obtained for the change in the relative position between the image sections. This provides that, in addition to the motion information originating from an information source outside the imaging system, images from the imaging sensor of the imaging system are additionally evaluated in order to capture the motion of the object even more precisely. Additional motion data is ascertained from the images in order to be able to better ascertain the relative position of the object for an intermediate image.

According to a further example embodiment, cyclic motion fields are ascertained and/or learned from the first image and images preceding the first image as the motion information and used for changing the relative position between the image sections. Cyclic motion fields are two-dimensional or three-dimensional fields that represent cyclic motions of the object caused by the heartbeat, for example. Such motion fields make it possible to be able to better predict motions in two-dimensional or three-dimensional space. In addition to a motion field, one or more other items of motion information may be used to better predict the motion for the intermediate image.

In another example embodiment, in addition to the motion information, at least one coarse image with reduced information content compared to the first image and the second image is obtained with the imaging sensor, and the intermediate image is generated from this coarse image together with information from the first image and/or the second image. Complete rendering of the first image and the second image leads to the corresponding latencies. Therefore, it may be favorable only to render a coarse image with reduced information content for the intermediate image so that the latency between the first image and the subsequent intermediate image may be correspondingly lower. The reduced information content may, for example, be achieved by only observing essential or prominent points of the moving object. For example, for the motion of a catheter, it is sufficient to know where the tip of the catheter is located and possibly a second point a few centimeters behind the tip. Using these two points and the image information from the first image, an intermediate image may then be constructed fairly precisely. However, the reduced information content may also be due to the fact that the coarse image is obtained with lower spatial resolution and/or reduced color or brightness resolution with the aid of the imaging sensor. A correspondingly more accurate resolution for the intermediate image may then be calculated based on the coarse image together with information from the first image. Hence, such a coarse image provides actual information about the position of the object at the time of the intermediate image, and the intermediate image is not based solely on an estimate.

Thus, according to the present embodiments, a method may also be provided for controlling medical imaging by generating an intermediate image with a method, as described above, evaluating the intermediate image with respect to one or more specifications, and generating control information for controlling image recordings following the intermediate image. For example, the intermediate image is checked for inconsistencies or uncertainties and, if these are present, the framerate is increased. For this purpose, a control signal or a respective trigger point for subsequent image recordings is, for example, generated as control information. Alternatively or additionally, the dose may also be changed with the aid of control information, for example, in the case of X-ray recordings. Hence, the intermediate image may also be used for finer control of the imaging apparatus.

As another example a medical imaging apparatus for generating an intermediate image according to a method as described above is provided. The medical imaging apparatus includes an imaging sensor for obtaining a first image and a second image of an object. In the first image, an image section of the object and a further image section are represented in a relative position to one another. The medical imaging apparatus also includes a capturing facility for obtaining motion information relating to the object independently of the first image and the second image (e.g., optionally all images) of the imaging sensor, and a computing facility configured to generate an intermediate image for presentation between the first image and the second image. In the intermediate image, the relative position between the image section of the object and the further image section is changed in dependence on the motion information from the capturing facility compared to the first image.

Therefore, in addition to the imaging sensor, the medical imaging apparatus has a separate capturing facility with which the motion information may be obtained independently of the imaging sensor. In one embodiment, the capturing facility may obtain the motion information independently of all images from the imaging sensor. The capturing facility and the imaging sensor may, for example, be implemented as two separate physical units.

The computing facility of the medical imaging apparatus is configured to calculate an intermediate image based on past images from the imaging sensor without a current signal from the imaging sensor. Thus, the computing facility serves for image processing and creating the intermediate image.

Further, according to the present embodiments, a computer program or computer program product is provided that includes instructions that, when the program is executed by a medical imaging apparatus of the type mentioned, cause the medical imaging apparatus to execute the method as described above.

### BRIEF DESCRIPTION OF THE DRAWINGS

FIG. 1 is a schematic representation of an example embodiment of an imaging apparatus;

FIG. 2 is a flowchart for generating an intermediate image according to an example embodiment; and

FIG. 3 shows a specific example of an image presentation with an intermediate image.

### DETAILED DESCRIPTION

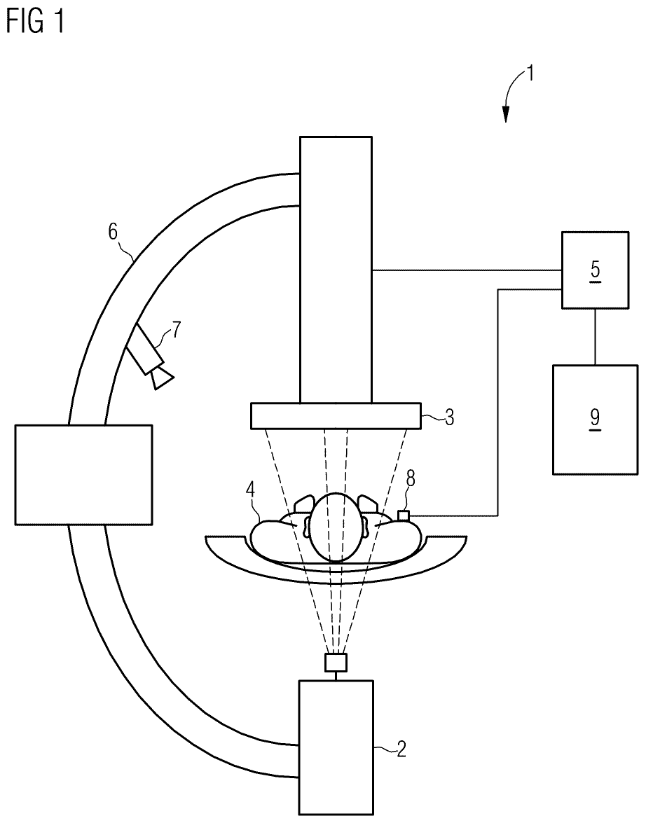

FIG. 1 is a schematic representation of an example embodiment of an imaging system 1 according to the improved concept, which is, for example, configured as an X-ray imaging system. The example in FIG. 1 represents a design of the X-ray imaging system or device according to the principle of a C-arm device with a rotatable and movable C-arm 6, that may be rotated and moved in order to image an object 4 to be imaged (e.g., patient, part of a patient, medical instrument in the patient, etc.) from different directions (e.g., with different recording angles). However, an imaging apparatus 1 according to the present embodiments may also be constructed according to other designs. For example, the present embodiments are not fundamentally limited to X-ray based imaging methods.

The imaging apparatus 1 in FIG. 1 thus includes, for example, an X-ray source 2 configured to generate X-rays and emit the X-rays in the direction of the object 4. An imaging sensor 3 of the imaging apparatus 1 containing, for example, a detector array of photodiodes in order to be able to detect X-ray quanta penetrating the object 4 is arranged on a side of the object 4 opposite the X-ray source 2. The imaging sensor 3 may then transmit the corresponding detector signals, for example, to a control facility or computing facility 5 of the imaging system 1 for further processing. Components 2 to 6 represent an imaging apparatus that may forward images of the imaging apparatus to an image processing apparatus 9. This may make any corrections to the recorded images or perform further processing.

The imaging system 1 may, for example, be configured to perform a rotational angiography method (e.g., based on the principle of subtraction angiography). In this case, the computing facility 5 may, for example, generate a plurality of two-dimensional projections recorded from different angles (also referred to as output images), and the image processing apparatus 9 may calculate a three-dimensional reconstruction from the plurality of two-dimensional projections, if necessary.

As a further source of information for detecting the motion of the object 4, at least one capturing facility is provided to capture the motion of the object 4. The capturing facility may have a camera 7 that is, for example, attached to the C-arm 6. Alternatively, the capturing facility or the camera 7 may also be arranged on another part of the imaging system 1 (e.g., on the imaging sensor 3).

Alternatively or additionally, the capturing facility may also have a sensor 8 that is attached directly to the object 4. For example, a heart phase detector is used as a sensor 8 that sends a corresponding signal to the computing facility 5.

The present embodiments are based on the idea of achieving a temporal extrapolation of intermediate images using medical device information and/or motion information. Thus, additional motion data of an object involved in the imaging is used.

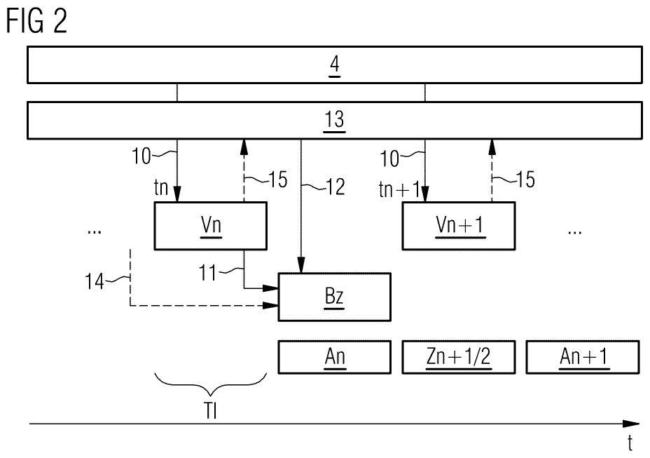

FIG. 2 shows a specific example embodiment of a method for generating intermediate images (e.g., for a medical imaging video sequence). Specifically, an X-ray video sequence is to be obtained from the object 4. For this purpose, X-ray images 10 (or also other images, such as ultrasound images, MRI images, etc.) are recorded of the object 4. The X-ray images 10 represent a physical reality. The object 4, which, for example, may be a patient, an examination object, a medical instrument, and so on, moves, and this motion is to be represented on the video sequence as a smooth motion. For this purpose, for example, an X-ray image 10 is in each case recorded at time tn, tn+1, and so on. If necessary, X-ray images are already recorded before time tn.

The X-ray image 10 at time tn (e.g., first image) is processed in a processing step Vn, while the X-ray image 10 at time tn+1 (e.g., second image) is processed in a processing step Vn+1. Corresponding processing steps may also be provided for the preceding and subsequent X-ray images.

The motion of the object 4 causes a relative position of two partial image sections to change from the first image to the intermediate image, from the first image to the second image, or from the intermediate image to the second image. This provides that it is not an image or not only an image as a whole that shifts, but image contents relative to one another. For example, the first image contains a catheter before a vascular junction, and the intermediate image or the second image contains the catheter after the vascular branch. In another example, the first image shows a chest section and a skull of a patient, and in the second image or the intermediate image, the head is rotated relative to the chest section.

A certain latency time T1 is required after the start of the processing step Vn until the corresponding frame n may be displayed in a display step. Similarly, the frame n+1 is also only displayed after the latency time T1 in a display step An+1.

In a calculation step Bz, an intermediate image is calculated for the time tn+½. The calculation represents a temporal extrapolation and is performed based on the one or more previous frames provided according to the arrow 11. Further, one or more items of motion information 12 from an additional system 13 are provided for the calculation step Bz for calculating the intermediate image. The additional system 13 may be a tracking system, a motion model, an optical camera, an EEG sensor, and the like. This motion information 12 from the additional system 13 is provided specifically for the time tn+½ (e.g., possibly also for other times). In any case, no X-ray recordings are available or required for this point in time. The arrow 14 indicates that earlier frames from previous X-ray image processing may be used to calculate the intermediate image. In addition, the arrows 15 indicate that information from the respective processing steps Vn, Vn+1 etc. may also be provided to the additional system 13 in order to generate the motion information 12. Once the intermediate image has been calculated after the processing step Bz, the intermediate image may be displayed in a display step Zn+½ between display step An for frame n and display step An+1 for frame n+1.

The steps shown in FIG. 2 can be repeated a number of (e.g., several) times on the time scale t in order to generate a corresponding video sequence with intermediate images.

Therefore, the algorithm for generating the intermediate image uses the motion information of the additional system 13. This motion information may also be context information or device information that indirectly contains the corresponding motion information. The algorithm may perform a temporal extrapolation for the image extrapolation. The algorithm may be supplemented or supported by further measures. One such measure would be segmentation and ascertaining the motion of certain objects based thereon. Known segmentation algorithms may be used for the segmentation. The segmented objects may be used to infer their motion.

Further, approaches for the learned extraction of cyclic motion fields from X-ray sequences may be used for the algorithm. Thus, in addition to the motion information 12 from the additional system 13, cyclic motion fields ascertained from previous recordings may be used for better prediction of the intermediate images.

An additional system 13 that is suitable for detecting heart phases and/or respiratory movement cycles may be used to obtain the motion information. Alternatively or additionally, the additional system may also use or generate an EEG signal or a signal from a ventilator.

Further, alternatively or additionally, the additional system 13 may use device data from the imaging system and/or further tracking data. For example, the motions of a C-arm relative to the examination object are available as device data. Further tracking data may be catheter data or instrument tracking data, but also tracking data from motions of a skin surface of the patient using a camera or other sensor technology.

The algorithm for intermediate image generation may be used not only for outputting the intermediate image. Rather, the algorithm may also be used to control further recordings. For example, the algorithm may be used to trigger additional time points for new X-ray image recordings (e.g., in the event of inconsistencies, indeterminacies, or uncertainties in the intermediate image frames generated). A subsequent comparison of the extrapolated intermediate image with the subsequent newly recorded image may also be used to control the further X-ray image recordings accordingly. For example, the frame rate of the X-ray image may be temporarily increased in the event of significant deviations.

Similarly to the change in the frame rate, the dose for the next X-ray images may also be controlled in dependence on the deviations of the intermediate image. The higher the calculated uncertainty or deviation, the higher the required X-ray dose or required X-ray image quality may be.

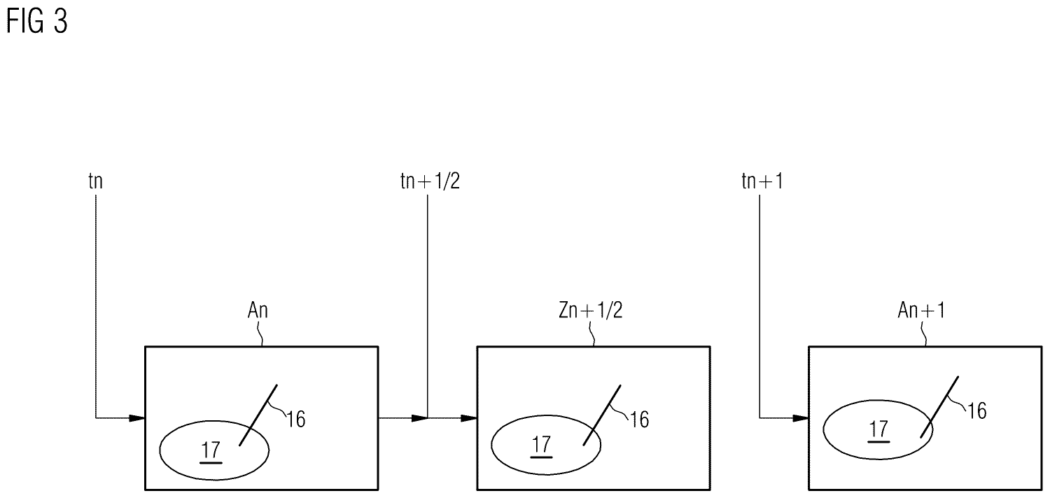

FIG. 3 represents an image sequence with intermediate image presentation according to the present embodiments in a specific example in which a needle 16 is moved relative to a liver 17. For a first image, display image An, an X-ray image recording of the liver 17 and the needle 16 is taken at time tn. After processing of the X-ray raw image data (not represented here), the display image An is presented delayed by the latency T1.

A second image obtained in a similar way is only available as a display image An+1 when an X-ray image recording has been taken again at a later time tn+1 and the image processing of the corresponding X-ray raw image data has taken place.

In the meantime (e.g., at time tn+½), one or more additional systems obtain motion information relating to the needle 16 relative to the liver 17. Alternatively, the additional system(s) may also obtain a first item of motion information relating to the needle 16 and a second item of motion information relating to the liver 17. The motion information may represent relative motions to other image content. For example, the motion information may be obtained from an external needle tracking system: “Needle has moved 1 mm toward the right at time tn+½ compared to time tn.” Similarly, an external sonography device may, for example, be used to obtain the motion information: “Liver has moved 0.5 mm upward at time tn+½ compared to time tn.” This motion information is used to extrapolate the intermediate image Zn+½. FIG. 2 shows that the needle 16 has moved to the right and the liver 17 has moved upward in the intermediate image Zn+½ compared to the display image An. In the display image An+1, the needle 16 has moved even further to the right, and the liver 17 has moved even further upward. Therefore, the intermediate image Zn+½ shows an estimated motion situation between the “real” images An and An+1.

The method described above enables smoother image perception during X-ray procedures with high frame rates. The image sequence is perceived as much smoother due to the intermediate image, thus facilitating a rapid response to the image content represented. Such rapid responses are, for example, required during catheter interventions on the heart.

At high X-ray frame rates of, for example, 60 fps, there is only a very slight deviation from the “real” X-ray images. Hence, the technique according to the present embodiments allows for smoother image perception without the risk of X-ray images being distorted by algorithms.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for generating an intermediate image in medical imaging, the method comprising:
obtaining a first image and a second image of an object with an imaging sensor, wherein, in the first image, an image section of the object and a further image section are represented in a relative position to one another;
obtaining motion information relating to the object independently of the first image and the second image of the imaging sensor; and
generating the intermediate image for presentation between the first image and the second image,
wherein in the intermediate image, the relative position between the image section of the object and the further image section is changed in dependence on the motion information compared to the first image, and
wherein the intermediate image is generated before the second image is available for presentation.

2. The method of claim 1, wherein the medical imaging is based on X-rays, magnetic resonance, or ultrasound.

3. The method of claim 1, wherein the intermediate image is calculated by a computing facility solely based on the first image and the motion information.

4. The method of claim 1, wherein the motion information is obtained independently of all images from the imaging sensor.

5. The method of claim 1, wherein the motion information is obtained by a camera with which the object is recorded independently of the imaging sensor.

6. The method of claim 1, wherein the motion information is obtained with the aid of a tracking system or a motion model.

7. The method of claim 1, wherein the motion information is obtained from control data for motion, from motion data from the imaging sensor, or from a combination thereof.

8. The method of claim 1, wherein the motion information is obtained with the aid of a non-imaging medical examination device.

9. The method of claim 1, wherein the object is a medical instrument.

10. The method of claim 1, further comprising:
obtaining, in addition to the motion information, segmentation information from images from the imaging sensor; and
obtaining further motion data for the change in the relative position between the image section of the object and the further image section from the obtained segmentation information.

11. The method of claim 1, further comprising:
ascertaining, learning, or ascertaining and learning cyclic motion fields from the first image and images preceding the first image as the motion information; and
using the cyclic motion fields for changing the relative position between the image section of the object and the further image section.

12. The method of claim 1, further comprising obtaining, in addition to the motion information, a coarse image with reduced information content compared to the first image and the second image with the imaging sensor,
wherein the intermediate image is generated from the coarse image together with information from the first image, the second image, or the first image and the second image.

13. A method for controlling medical imaging, the method comprising:
generating an intermediate image, the generating comprising:
obtaining a first image and a second image of an object with an imaging sensor, wherein, in the first image, an image section of the object and a further image section are represented in a relative position to one another;
obtaining motion information relating to the object independently of the first image and the second image of the imaging sensor; and
generating the intermediate image for presentation between the first image and the second image, wherein in the intermediate image, the relative position between the image section of the object and the further image section is changed in dependence on the motion information compared to the first image, and wherein the intermediate image is generated before the second image is available for presentation;
evaluating the intermediate image with respect to one or more specifications; and
generating control information for controlling image recordings following the intermediate image.

14. The method of claim 13, wherein the medical imaging is based on X-rays, magnetic resonance, or ultrasound.

15. The method of claim 13, wherein the intermediate image is calculated by a computing facility solely based on the first image and the motion information.

16. The method of claim 13, wherein the motion information is obtained independently of all images from the imaging sensor.

17. The method of claim 13, wherein the motion information is obtained by a camera with which the object is recorded independently of the imaging sensor.

18. The method of claim 13, wherein the motion information is obtained with the aid of a tracking system or a motion model.

19. A medical imaging apparatus for generating an intermediate image, the medical imaging apparatus comprising:
an imaging sensor for obtaining a first image and a second image of an object, wherein, in the first image, an image section of the object and a further image section are represented in a relative position to one another;
a capturing facility configured to obtain motion information relating to the object independently of the first image and the second image, and
a computing facility configured to generate an intermediate image for presentation between the first image and the second image,
wherein, in the intermediate image, the relative position between the image section of the object and the further image section is changed in dependence on the motion information from the capturing facility compared to the first image, and the intermediate image is generated before the second image is available for presentation.
